(19) United States
(12) Patent Application Publication
(10) Pub. No.: US 2010/0001957 A1
(43) Pub. Date: Jan. 7, 2010

(54) DISPLAY APPARATUS

(76) Inventor: Kyung Taek LEE, Gumi-city (KR)

Correspondence Address: KED & ASSOCIATES, LLP, P.O. Box 221200, Chantilly, VA, 20153-1200, US

(21) Appl. No.: 12/424,719

(22) Filed: Apr. 16, 2009

(30) Foreign Application Priority Data
Jul. 7, 2008 (KR) 10-2008-0065242

(51) Int. Cl. G06F 3/02

(52) U.S. Cl. 345/168

(57) ABSTRACT

A display apparatus includes a controller and an input unit having one or more local keys located on a side of a case. The controller controls display of a guide screen in a display area that is based on mounting positions of the one or more local keys. The guide screen is generated in response to an input received in association with one of the local keys and includes information that provides an indication of mounting positions of the local keys on the side of the case.

The present application claims priority under 35 USC §§ 119 and 365 to Korean Patent Application No. 10-2008-0065242, filed on Jul. 7, 2008, the contents of which is incorporated by reference herein.

### BACKGROUND

1. Field

One or more embodiments described herein relate to displaying information.

2. Background

A display apparatus has a plurality of keys for controlling various operations. The keys may include, for example, one or more of a volume key, a channel key, a power key, and a menu key. In one type of display apparatus, the keys are located on a front side of the display in a horizontal or vertical direction. In another type of display apparatus (shown in FIG. 1), the keys are located on a side of the display with corresponding labels. The key arrangements in these display apparatus have proven undesirable in terms of convenience and their tendency to increase the size of the display.

### BRIEF DESCRIPTION OF THE DRAWINGS

FIG. 1 is a diagram showing key arrangement in a related-art display apparatus.

FIG. 2 is a diagram showing one embodiment of a display apparatus.

FIG. 3 is a diagram showing an example of an operation setting screen of a local key guide function according to the aforementioned embodiment.

FIG. 4 is a diagram showing another example of a local key guide screen according to the aforementioned embodiment.

FIG. 5 is a diagram showing an example of an operation screen of local keys according to one embodiment.

FIGS. 6 and 7 are diagrams showing additional example of local key guide screens according to the aforementioned or other embodiments.

FIG. 8 is a flow chart showing steps included in one embodiment of a method for controlling a display apparatus having local keys.

FIG. 9 is a flow chart showing steps included in another embodiment of a method for controlling a display apparatus having local keys.

### DETAILED DESCRIPTION

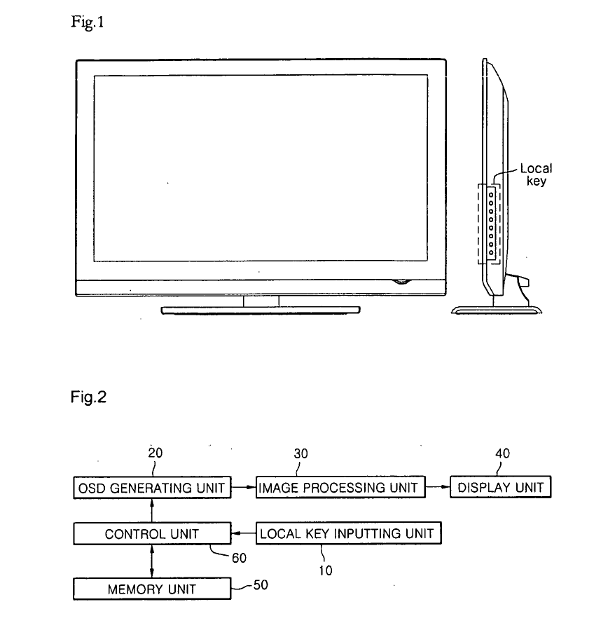

FIG. 2 shows one embodiment of a display apparatus having local keys. This apparatus includes a local key inputting unit 10, an on-screen display generating unit 20, an image processing unit 30, a display unit 40, a memory unit 50, and a control unit 60.

The local key inputting unit has one or more local keys mounted on at least one side of a display case or housing. The local key inputting unit 10 may be installed in or along the case of the display apparatus and is configured to receive operation commands from a user. The inputting unit may include a plurality of local keys suitable to match the type of display apparatus and/or the purposes for which the display apparatus is designed or intended to be used.

According to one arrangement, the local key inputting unit may be vertically oriented along a side of the case or housing. In other embodiments, the local key inputting unit may be horizontally oriented along an upper or lower side of the display. Also, the local key inputting unit may include one or more local keys. The local keys may include, for example, a volume key for adjusting a volume of speakers located in or coupled in association with the display, a channel key for changing a channel, a power key for controlling an operating power of the display, a menu key for executing a menu, an input switching key for switching an input mode of the display, and a confirm key for selecting a specific menu. Additional or different keys may be provided as necessary.

The OSD generating unit generates a guide screen for allowing a person to use and generate control inputs based on the local keys.

The image processing unit performs processing operations related to the guide screen, so that the screen appears in a desired displayable form.

The display unit displays the guide screen processed by the image processing unit 30. The display unit may be a Digital Light Processing (ALP) unit, a Liquid Crystal Display (LCD) unit, a Plasma Display Panel (PDP) unit or any other type of display.

The memory unit stores various forms of data related to the guide screen, local key settings, and/or other information. The memory unit may be an electrically erasable programmable read-only memory (EEPROM) or any one of a number of other known storage devices.

The control unit controls the guide screen based on settings generated when one or more local keys are manipulated by a user. The control unit may also control the guide screen to be displayed in specific screen area based on the position in which the local keys are mounted on the case or housing of the display.

The control unit 60 may also control the overall operation of the display apparatus. For example, the control unit may output a control signal based on an input from one or more of the local keys when activation of or an input from the one or more local key is detected. That is, the control unit determines whether to set the local key guide function when an input from a specific local key of the local key inputting unit 10 is detected.

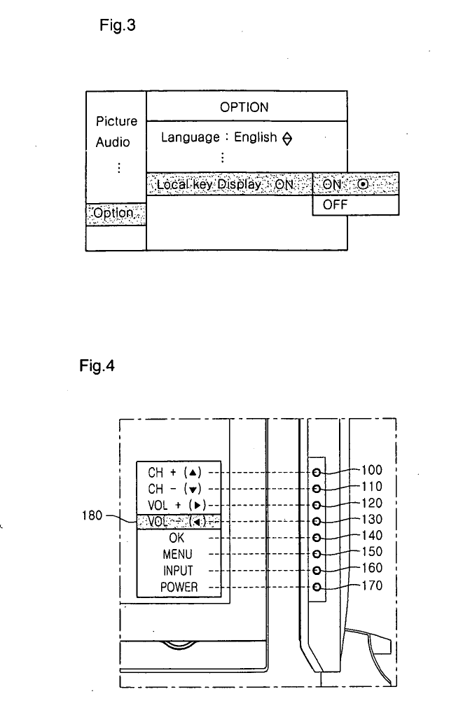

FIG. 3 shows an example of a menu displayed in a main display area of the screen. The menu may be used to control various functions of the display as well as to set whether to perform a local key guide function. With this screen, the user can provide inputs for setting whether to perform the local key guide function in connection with an option item, and whether to turn on or off the local key guide function.

When a user turns on the local key guide function through activation of the option item, control unit 60 may control the guide screen to be displayed for guiding the input of the local key when the input of the local key is detected. When the user turns off the local key guide function through the option item, the control unit may control only the operation corresponding to the detected local key when the input of the local key is detected.

The OSD generating unit 20 generates the guide screen for guiding an input of the local key based on a control signal of the control unit. The guide screen is signal-processed through image processing unit 30 and displayed through display unit 40. To perform these functions, the image processing unit may include a video decoder for decoding an externally input video signal, a scaler for scaling the decoded video signal based on a format of the display unit, and a mixer for mixing the scaled video signal and the guide screen.

FIG. 4 shows an example of a local key guide screen 180 that may be generated in accordance with one or more embodiments described herein. Generation of the guide screen may be based on use of the local key inputting unit. For example, when one of the keys of the local key inputting unit is pressed or otherwise activated, guide screen 180 is displayed on the screen at a position proximate the keys for guiding the user in generating a control input corresponding to one of the keys. As further shown in FIG. 4, the guide screen may be displayed in a screen area that corresponds to a mounting position of the local keys of the local key inputting unit.

For example, when the local keys are installed at a lower right portion of the display apparatus, the guide screen may be displayed in a screen area that corresponds to the lower right portion of the display unit 40. Similarly, when the mounting position of the local key is at a lower left portion of the display apparatus, the guide screen may displayed in a screen area that corresponds to the lower left portion of the display unit 40.

The local keys may include a first local key 100 for executing a channel-up function and/or a cursor movement function, a second local key 110 for executing a channel-down function and/or a cursor movement function, a third local key 120 for executing a volume-up function and/or a cursor movement function, a fourth local key 130 for executing a volume-down function and/or a cursor movement function, a fifth local key 140 for selecting a specific menu, a sixth local key 150 for executing a menu function, a seventh local key 160 for executing an input mode switching function, and an eighth local key 170 for executing a power on/off function.

In performing a cursor movement function, the channel keys may move the position of a cursor in a main display (e.g., main menu) area of the screen. The menu in the main display area may be generated, for example, to provide further options related to one of the local keys when one of the local keys are pressed or otherwise activated. Of course, other or different keys than those shown in the figures may be included based on the specific operations associated with the type of display being used.

The guide screen may be generated to include a number of other features. For example, the guide screen may be an arrangement screen of the local keys provided in the display apparatus, and information related to the functions of the local keys may also be displayed on the arrangement screen.

In addition, the state of the displayed guide screen may be determined according to the arrangement states of the local keys. In other words, as indicated by the dotted lines in FIG. 4, a first local key menu for explaining the position and function of a corresponding local key may be displayed in a main display area corresponding to a mounting position of first local key 100 in the display apparatus. Likewise, a second local key menu for explaining the position and function of a corresponding local key may be displayed in the main display area corresponding to a mounting position of the second local key 110. And, third, fourth, fifth, sixth, seventh and eighth local key menus for explaining the positions and functions of the other local keys may be displayed in the main display area corresponding to mounting positions of the third, fourth, fifth, sixth, seventh and eighth local keys 120, 130, 140, 150, 160 and 170, respectively.

Through the generation of this guide screen and its corresponding menus, a user can accurately use and correctly input signals corresponding to the local keys, while maintaining a posture that allows him to simultaneously watch the screen (e.g., a word-processing screen, other program screens, or even TV) from a front perspective. This allows the user to avoid drawbacks associated with other displays, that require users to re-position their heads so that they can look along the side of the display where the keys are included. These latter types of displays are inconvenient because the user cannot use the keys and look at the display screen contents at the same time.

Also, generating a guide screen in accordance with the embodiments described herein allows a user to easily check the arrangement states of and information relating to functions of the local keys, which are disposed in an area that is hidden or out of sight of the viewer when the viewer is looking at a position directly in front of the screen. Furthermore, the user can efficiently input his or her desired local keys using the guide screen.

In addition, when an input associated with one of the local keys is detected after the guide screen is displayed, control unit 60 may control display of information associated with the local key on the guide screen in a manner which allows it to be discriminated from other local keys. For example, when an input associated with a specific local key is detected in a state where the guide screen is displayed, the control unit may control the menu of the detected local key to be discriminated from the other local key menus.

FIG. 5 shows an example of an operation screen associated with the local keys. As shown, when an input associated with a fourth one 130 of the local keys is detected in a state where guide screen 180 is displayed, a menu corresponding to the fourth local key displayed within the guide screen 180 is highlighted so that it can be discriminated from the other local keys. In addition, when the an input is received from the fourth local key, volume level information 210 based on the input corresponding to the fourth local key may be displayed on one side of the display unit 40.

Likewise, when an input is received in association with the local key that changes the current channel, channel number information 220 may be generated and displayed based on this input. When an input is received in association with the sixth local key 150, a menu screen for enabling setup of various options based on the inputted sixth local key 150 may be displayed. In this case, the control unit 60 changes the form of the displayed guide screen according to the kinds of the local keys, the inputs of which are detected. That is, when the input of first local key 100 is detected, the channel-up operation is performed. In this case, other local keys are not inputted according to the input of the first local key 100.

However, when the input of the sixth local key 150 is detected, the menu screen for setting the options is displayed. Thereafter, the local keys (up/down/left/right/selection local keys) for position movement of the selected cursor and selection of the specific menu may be continuously inputted on the displayed menu screen.

Accordingly, when an input of the local key is detected, the control unit 60 checks the kind of the detected local key and checks the local key which is inputtable in the current state, based on the kind of the checked inputted local key. That is, when any one of the first local key 100, the second local key 110, the third local key 120, and the fourth local key 130 is inputted in the power-on state, the user will be able to input all local keys including the above local key. However, when the user inputs the eighth local key 170 in the power-on state, the user will be able to input only the eighth local key 170 because the current state is the power-off state.

In addition, when the user inputs the sixth local key 150, the user will be able to input only the first local key, the second local key, the third local key, the fourth local key, the fifth local key and the sixth local key.

Therefore, when the input of the specific local key is detected in a state that the guide screen is displayed, the control unit 60 controls the displaying of the guide screen including only the local key which the user can input in the current state.

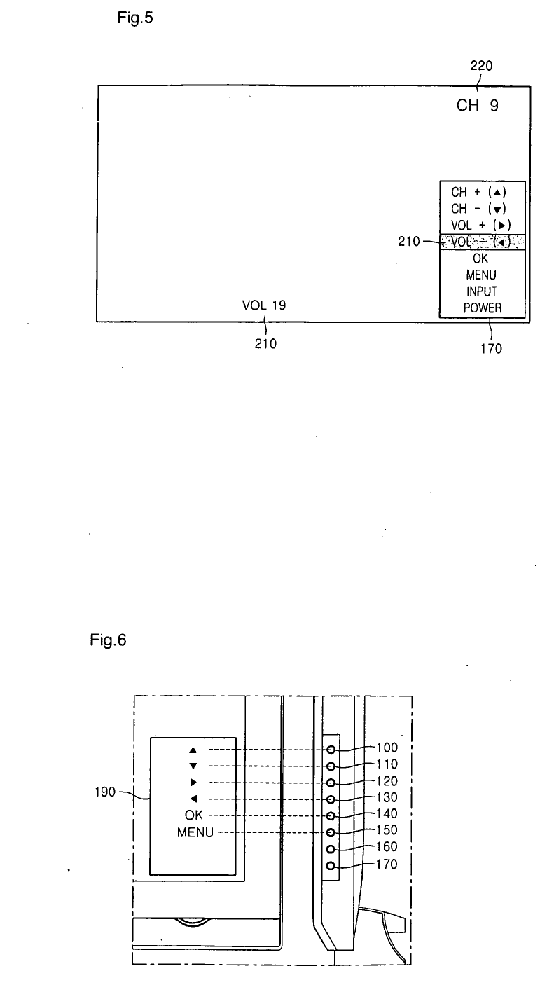

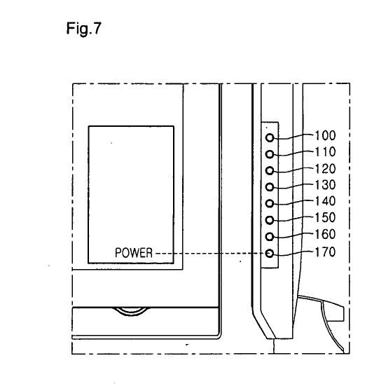

FIGS. 6 and 7 show another example of a local key guide screen that may be generated in accordance with the embodiments described herein. As shown, when an input associated with the sixth local key 150 is detected (e.g., when the user presses the sixth local key), a guide screen 190 may be generated to display settings that correspond to only the first through sixth local keys so that the user can easily check local key information which is inputtable in the current state.

In this case, the information on the functions of the local keys displayed within the guide screen 190 contains information of the functions which can be currently used by the user. That is, local keys which execute a plurality of functions exist among the above-described local keys. For example, the first local key 100 executes a channel-up operation function and a selection cursor movement function, and the second local key 110 executes a channel-down operation function and a selection cursor movement function.

Therefore, when a single local key performs a plurality of functions, control unit 60 displays only the function information, which can be currently used among the plurality of functions, as the function information of the corresponding local key.

Also, referring to FIG. 7, when a user generated an input associated with (e.g., presses) eighth local key 170, a guide screen generated for operations associated with the eighth local key is displayed, so that the user can easily check the local key information which is inputtable in the current state. Therefore, the user can easily check the function and position of the local key which the user can input in the current state, and can correctly anticipate the position of the next local key and execute the function of the next local key, thereby reducing operations of inputting unnecessary local keys.

A display apparatus with local keys according to any one of the aforementioned embodiments provides an OSD containing information on the position and function of the local key, thereby eliminating the inconvenience of the input of the local key according to various designs such as the large size of the display apparatus and the application of touch local keys. Furthermore, it is possible to reduce movement of the user's body and also reduce erroneous manipulation and unnecessary key input until the execution of desired functions, thereby increasing the user's convenience and satisfaction of the product.

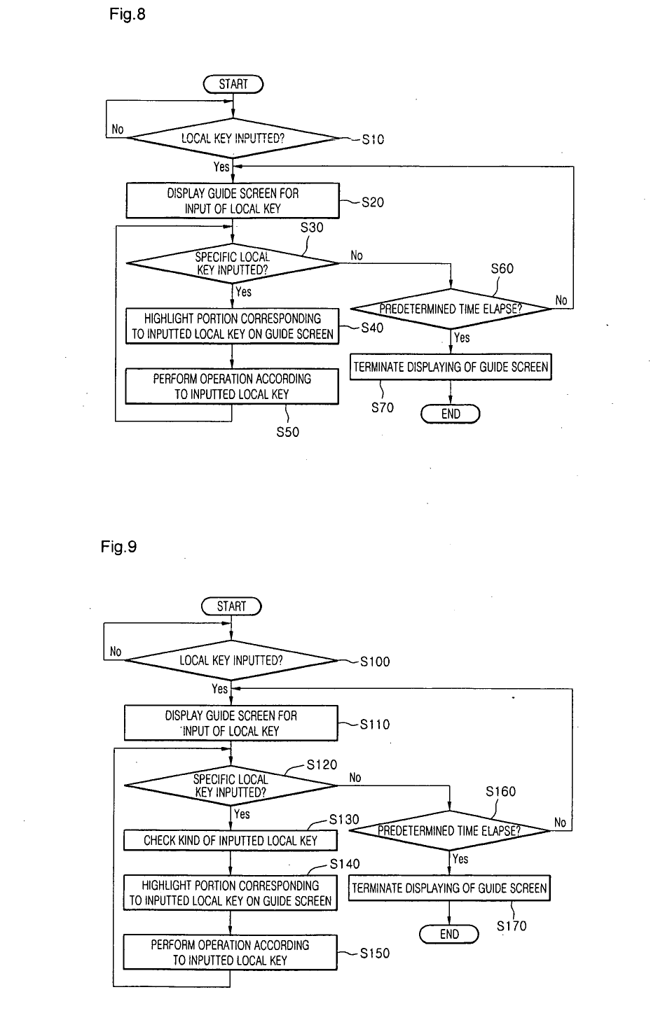

FIG. 8 shows steps included in one embodiment of a method for controlling a display apparatus, which, for example, may correspond to any of the aforementioned embodiments of the display apparatus discussed relative to FIGS. 2-7. Referring to FIG. 8, a determination is made as to whether an input has been received in association with one of the local keys (S10). The input may be received from an external signal source or, for example, as a result of a user pressing or otherwise activating one of the local keys.

When an input corresponding to a local key is detected, a guide screen for receiving an input in association with the local keys is generated and displayed (S20). The guide screen may provide text, graphics, and/or other information related to or identifying the keys. Moreover, the guide screen may be displayed in a display area that corresponds to a mounting position of the local keys provided in the display apparatus. Also, the guide screen may be an arrangement screen of the local keys, and the arrangement screen may contain information on the function and use of the local keys.

Next, it is determined whether an input associated with a specific one of the local keys is received during a time when the guide screen is displayed. (S30). That is, it is determined whether an input of a specific local key is detected in a state that the guide screen is displayed. When an input of a specific local key is detected, a local key menu corresponding to that local key is highlighted on the guide screen (S40). That is, when an input of the specific local key is detected in a state that the guide screen is displayed, the menu of the detected local key is displayed in such a manner that it is discriminated from the other local keys. The user may then generate inputs corresponding to various options in the menu using, for example, the local keys corresponding to those options.

When an input of the specific local key is not detected, it is determined whether a predetermined time has elapsed from the time when the guide screen was first displayed (S50). Before the predetermined time elapses, process control returns to operation S20. However, when the predetermined time elapses, display of the guide screen is terminated, e.g, the guide screen is no longer displayed (60).

According to this method, a user can easily check the arrangement states of the local keys, which are disposed in the area out of sight from a front perspective as well as information on the functions of the local keys, based on the displayed guide screen. Furthermore, the user can efficiently input his or her desired local keys.

FIG. 9 shows another embodiment of a method for controlling the display apparatus with the local keys. Initially, it is determined whether an input has been received in association with a specific one of the location keys (S100). The input may be received, for example, from an external signal source or as a result of a user pressing or otherwise activating one of the local keys.

When an input corresponding to a specific local key is detected, a guide screen for receiving an input in association with one of the local keys is displayed in (S110). The guide screen may include text, graphics, and/or other information identifying the function keys or the operations associated therewith. Also, the guide screen may be displayed in a display area corresponding to mounting positions of the local keys provided in the display apparatus. Also, the guide screen may be substantially an arrangement screen of the local keys, and the arrangement screen contains information on the function of the local keys.

Next, it is determined whether an input has been received for a specific one of the local keys in a state or during a time when the guide screen is displayed. (S120). That is, it is determined whether the input of the specific local key is detected in a state that the guide screen is displayed. When the input associated with one of the local keys is detected during this time or in this state, the kind of local key is detected (130).

Next, it is determined which local key is inputtable in the current state based on the checked kind of the inputted local key (S140). For example, when an input associated with the sixth local key 150 is detected, the current state is a state in which the menu screen is displayed. Thus, the local keys which the user can input are the first local key, the second local key, the third local key, the fourth local key, the fifth local key, and the sixth local key.

Likewise, when the local key, the input of which is detected in the power-on state, is the eighth local key 170, the current state is the power-off state. Thus, the local key which the user can currently input is the eighth local key 170.

The guide screen including only the checked local key which is inputtable is displayed in operation S150. For example, when an input associated with the sixth local key 150 is detected, a guide screen including only the first local key, the second local key, the third local key, the fourth local key, the fifth local key and the sixth local key is displayed.

Also, when an input associated with the eighth local key 170 is detected, a guide screen including only the eighth local key 170 is displayed. The user can easily check the information on the local key which the user can input in the current state.

Furthermore, the local keys which execute a plurality of functions exist among the above-described local keys. For example, the first local key 100 executes the channel-up operation function and the selection cursor movement function, and the second local key 110 executes the channel-down operation function and the selection cursor movement function. Therefore, when a specific local key existing on the guide screen performs a plurality of functions, the guide screen including only the function information, which can be currently used among the plurality of functions, is displayed.

When the input of the specific local key is not detected in S120, it is determined in operation S160 whether a predetermined time elapses from the time when the guide screen is displayed. When the predetermined time does not elapse in operation S120, the process returns to operation S110. On the other hand, when the predetermined time elapses in operation S12, the displaying of the guide screen is terminated in operation S170.

According to one embodiment, the OSD containing the information on the position and function of the local key is provided, thereby eliminating the inconvenience of the input of the local key according to various designs such as the large size of the display apparatus and the application of touch local keys.

Furthermore, it is possible to reduce the movement of the user's body and also reduce erroneous manipulation and unnecessary key input until the execution of desired functions, thereby increasing the user's convenience and satisfaction of the product.

Thus, in accordance with one or more of the aforementioned embodiments, the present disclosure relates to a guide function which enables a local key to be inputted more efficiently in a display apparatus. Embodiments provide a display apparatus having a guide function to enable users to input local keys more efficiently, and a control method of the display apparatus. Furthermore, since the positions and functions of the local keys are displayed in an on screen display (OSD) form, the users can easily input their desired local keys while watching on TV, without changing their postures.

Moreover, on the OSD where the positions and functions of the local keys are displayed, the local key inputted by the user is displayed in a manner that it is discriminated from the other local keys, so that the users can easily check kinds of the inputted local keys.

In one embodiment, a display apparatus with a plurality of local keys includes: a local key inputting unit comprising at least one or more local keys at one side of a case of the display apparatus; and a control unit controlling a displaying of a guide screen for providing information on mounting positions of the local keys when an input of the local keys is detected, wherein the control unit controls the displaying of the guide screen for providing the information on the mounting positions of the local keys in a display area corresponding to the mounting positions of the local keys provided in the display apparatus.

In another embodiment, a method for controlling a display apparatus with a plurality of local keys includes: detecting an input of local keys; and displaying a guide screen for providing information on mounting positions of the local keys when the input of the local keys is detected, wherein the guide screen is displayed in a display area corresponding to the mounting positions of the local keys provided in the display apparatus.

In further another embodiment, a method for controlling a display apparatus with a plurality of local keys includes: detecting an input of local keys; displaying an initial guide screen including a local key arrangement screen for providing information on mounting positions of the local keys; detecting an input of a specific local key in a state that the initial guide screen is displayed; checking an inputtable local key in a current state, based on kinds of the local keys, the inputs of are detected; and displaying the guide screen including only a checked local key menu.

According to the embodiment, the OSD containing the information on the position and functions of the local keys is provided, thereby eliminating the inconvenience of the input of the local keys according to various designs such as the large size of the display apparatus and the application of touch local keys.

Furthermore, it is possible to reduce the movement of the user's body and also reduce erroneous manipulation and unnecessary key input until the execution of desired functions, thereby increasing the user's convenience and satisfaction of the product.

In addition to the foregoing features, the display apparatus may be provided with a control feature that allows the position of the guide screen to be changed according to a user's demand or preference independently of the mounting positions of the local keys. However, it may be preferable in many cases to display the guide screen in a display area that correspond to the mounting positions of the local keys, in order to allow a user more efficiently generate inputs using the local keys. Therefore, in some embodiments, the aforementioned control feature may be omitted, so that they user does not have the ability to arbitrarily change the position of the guide screen.

According to another embodiment, a motion detector may be included in the display. The motion detector may detect a user's hand at a predetermined position relative to the local keys. The detector may be placed in a position that detects the user's hand near the local keys or at another location relative to the display.

When the detector detects a user's hand, a guide screen in accordance with one or more of the aforementioned embodiments may automatically be displayed to aid the user in using the local keys without having to change the position of his or her eyes, e.g., while looking at the screen. A processor in the display screen, coupled to the detector, may control the generation of the guide screen. In alternative embodiments, the motion detector may be incorporated within a keyboard, a separate module coupled to the keyboard or computer body, or in some peripheral device coupled to the computer or display, e.g., a mouse. In another embodiment, movement of the mouse may trigger generation of the guide screen. The motion detector or mouse may send signals to the display processor via a wire line or wirelessly using, for example, a Bluetooth or other short-range wireless protocol.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display apparatus, comprising:
an input unit having one or more local keys located on a side of a case; and
a controller to control display of a guide screen in a display area that is based on mounting positions of the one or more local keys, wherein the guide screen is generated in response to an input received in association with one of the local keys and includes information that provides an indication of mounting positions of the local keys on the side of the case.

2. The display apparatus of claim 1, further comprising:
an on screen display (OSD) generator to generate the guide screen based on a control signal from the controller; and
a display unit to display the guide screen generated by the OSD generator in the display area corresponding to the mounting positions of the one or more local keys.

3. The display apparatus of claim 1, wherein the guide screen is an arrangement screen that displays information indicative of mounting states of the one or more local keys.

4. The display apparatus of claim 3, wherein the arrangement screen includes function information corresponding to the one or more local keys.

5. The display apparatus of claim 3, wherein the controller changes a form of the arrangement screen based on kinds of the local keys when inputs corresponding to the local keys are detected.

6. The display apparatus of claim 3, wherein the controller highlights a menu corresponding to one of the local keys whose input is detected in a manner that discriminates the menu from the other local key menus.

7. The display apparatus of claim 1, further comprising:
a motion detector to detect motion at a predetermined position relative to the display apparatus, the controller automatically generating the guide screen in response to a detection signal output from the motion detector.

8. A method for controlling a display, comprising:
detecting an input associated with one or more local keys of the display; and
displaying a guide screen that provides information on mounting positions of the one or more local keys in response to detection of the input, wherein the guide screen is displayed in a display area corresponding to the mounting positions of the local keys provided in the display apparatus.

9. The method of claim 8, wherein the displaying the guide screen comprises:
displaying an arrangement screen of the local keys in a display area that corresponds to the mounting positions of the local keys.

10. The method of claim 9, wherein the displayed arrangement screen of the local keys contains information on function of the local keys.

11. The method of claim 9, further comprising:
detecting an input associated with a specific local key in a state or during a time when the guide screen is displayed; and
displaying a menu corresponding to the specific local key on the guide screen so that the local key menu is discriminated from the other local key menus.

12. The method of claim 8, further comprising:
changing a form of the guide screen based on kinds of the local keys when inputs corresponding to the local keys are detected, the form of the guide screen changed in a state or during a time when the guide screen is displayed.

13. The method of claim 12, wherein changing of the guide screen comprises displaying in the guide screen only local keys which are inputtable in a current state.

14. The method of claim 8, further comprising:
detecting motion proximate the display; and
automatically generating the guide screen based on detection of the motion.

15. A method for controlling a display, comprising:
detecting an input associated with one or more local keys of the display;
displaying an initial guide screen that includes a local key arrangement screen that includes information indicative of mounting positions of the one or more local keys;
detecting an input associated with a specific one of the local keys in a state or during a time when the initial guide screen is displayed;
checking an inputtable local key in a current state, based on kinds of the local keys, the inputs of which are detected; and
displaying the guide screen to include only a checked local key menu.

16. The method of claim 15, wherein the displayed guide screen is displayed in a display area corresponding to the mounting positions of the local keys provided in the display apparatus.

17. The method of claim 15, wherein when a single local key performs a plurality of functions, the guide screen of the local key displays information on a currently usable function among the plurality of function.
